(19) United States
(12) Patent Application Publication
(10) Pub. No.: US 2022/0344918 A1
(43) Pub. Date: Oct. 27, 2022

(54) RINGS ROTABLY COUPLED TO SLEEVES TO ACCOMMODATE CABLES

(71) Applicant: Hewlett-Packard Development Company, L.P., Spring, TX (US)

(72) Inventor: Tien Liang CHUNG, Taipei City (TW)

(73) Assignee: Hewlett-Packard Development Company, L.P., Spring, TX (US)

(21) Appl. No.: 17/236,877

(22) Filed: Apr. 21, 2021

(51) Int. Cl. H02G 3/04; F16M 11/22

(52) U.S. Cl. CPC H02G 3/0456; F16M 11/22

(57) ABSTRACT

According to examples, an apparatus may include a sleeve and a ring rotatably coupled to the sleeve. The sleeve may extend between a body of an electronic device and a base, and may have a recess to accommodate a cable. The ring may extend across an opening of the recess in a locked position and may be positioned behind the recess in an open position.

### BACKGROUND

Electronic devices, such as computers, may have a large number of cables that are connected to the backs of the electronic devices. In many instances, these cables may not be tied down, which may create messes around the electronic devices and/or be aesthetically displeasing.

### BRIEF DESCRIPTION OF THE DRAWINGS

Features of the present disclosure are illustrated by way of example and not limited in the following figure(s), in which like numerals indicate like elements, in which:

FIG. 1A shows an exploded perspective view of an example apparatus that may include a sleeve to accommodate cables and a ring to be rotatably coupled to the sleeve to secure the cables;

FIG. 1B shows a perspective view of the example apparatus depicted in FIG. 1A, in which the ring may be rotatably coupled to the sleeve and positioned in an open position;

FIGS. 2A and 2B, respectively, show rear cutaway views of the example apparatus depicted in FIGS. 1A and 1B, in which the ring is positioned in a closed position and a locked position;

FIG. 3 shows a perspective view of an example electronic device in which the example apparatus depicted in FIGS. 1A to 1C may be implemented;

FIG. 4 shows a perspective view of an example stand for an electronic device, in which the stand may include a support to accommodate the example apparatus including the sleeve and the ring depicted in FIGS. 1A-1B and 2A-2B;

FIGS. 5A to 5C, respectively, show perspective views of an example cable lock assembly which may include the sleeve and the ring depicted in FIGS. 1A to 1C, and which may be installed in the stand depicted in FIG. 4, in which the ring may be positioned in an open position, a closed position, and a locked position; and

FIGS. 6A to 6C, respectively, show rear cutaway views of the example sleeve, the example ring, and the example stand depicted in FIGS. 5A to 5C.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Electronic devices, such as all-in-one (AIO) computers, display monitors, and/or the like, may connect to many different external or peripheral devices. Generally, a large number of cables may be connected to ports at a rear of a computing device or a display monitor. The cables may include cables for data, peripheral devices, power, and/or the like. In many instances, these cables may not be tied down or hidden, and as such, may often create a dishevelled appearance in areas around the electronic devices. Furthermore, in some solutions for managing loose cables, it may be difficult to quickly and easily tie, untie, and/or retie the cables. For instance, when using certain types of cable ties to secure loose cables, it may be difficult to untie the cable ties to reroute the cables or the cable ties may not be reused.

Disclosed herein are apparatuses that may facilitate routing and securing of cables around electronic devices, such as computers, computer monitors, television monitors, and/or the like. In some examples, an apparatus may include a sleeve to accommodate cables and a ring to lock the cables in the sleeve. The sleeve and the ring may be disposed in a channel formed inside a stand or a support inside the stand. In some examples, the sleeve may extend between a body of the electronic device and a base. The sleeve may have a recess, which may accommodate the cables, and the ring may be rotatably coupled to the sleeve to secure the cables in the recess. In some examples, the ring may extend across an opening of the recess when placed in a locked position to secure the cables in place. The ring may also be positioned in an open position, in which the ring may be rotated behind the recess to allow the cables to be moved, removed, or rearranged. As discussed herein, the apparatus may reduce clutter and improve aesthetics of a work area around the electronic devices by routing and securing cables around the electronic devices, and may allow the user to more easily lock and unlock the cables, while enabling reuse of the apparatus for securing cables.

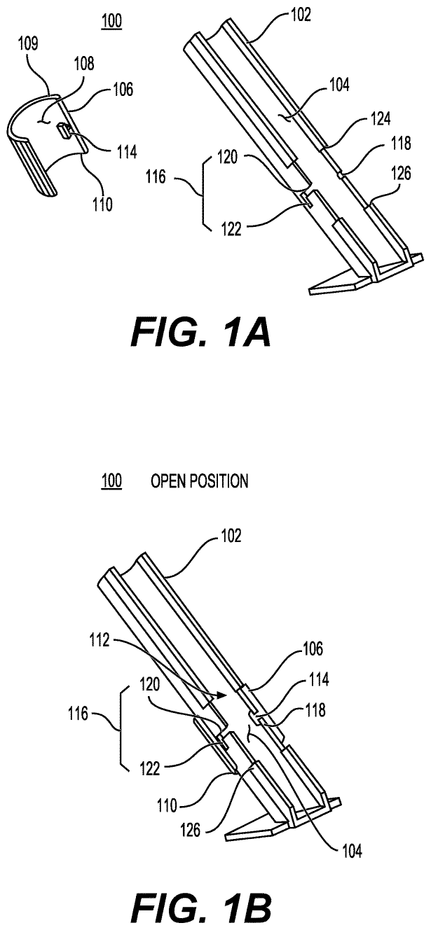

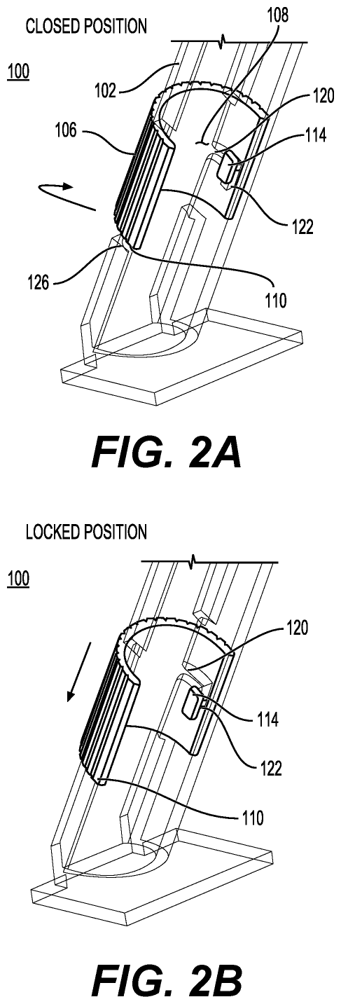

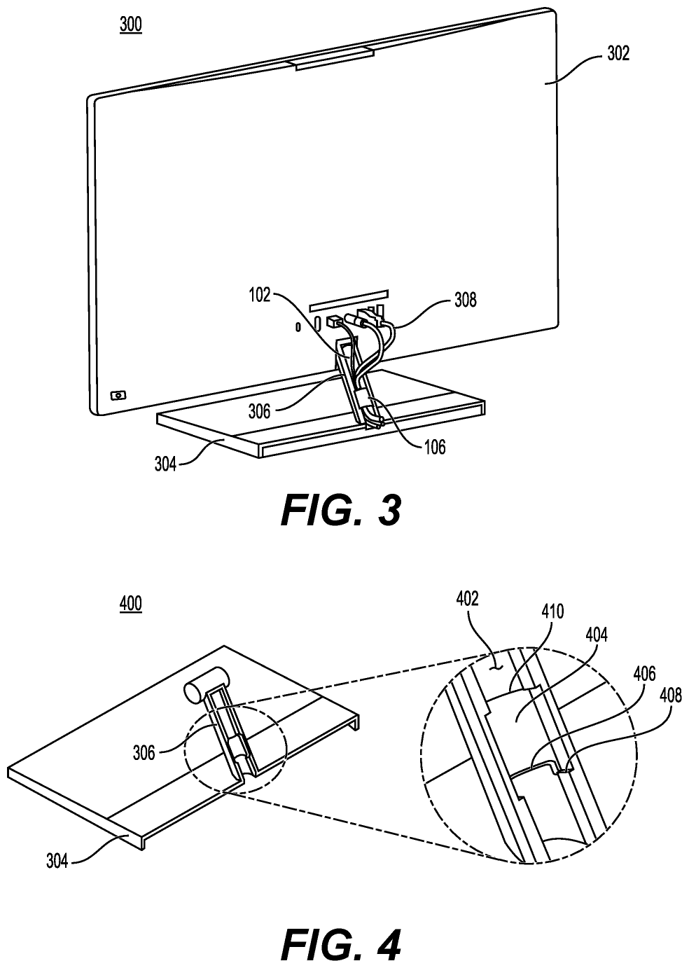

Reference is first made to FIGS. 1A to 1B, 2A to 2B, and 3. FIG. 1A shows an exploded perspective view of an example apparatus 100 that may include a sleeve 102 to accommodate cables and a ring 106 to be rotatably coupled to the sleeve 102 to secure the cables. FIG. 1B shows a perspective view of the example apparatus 100 depicted in FIG. 1A, in which the ring 106 may be rotatably coupled to the sleeve 102 and positioned in an open position. FIGS. 2A and 2B, respectively, show rear cutaway views of the example apparatus 100 depicted in FIGS. 1A and 1B, in which the ring 106 is positioned in a closed position and a locked position. FIG. 3 shows a perspective view of an example electronic device 300 in which the example apparatus 100 depicted in FIGS. 1A to 1B may be implemented. It should be understood that the apparatus 100 depicted in FIGS. 1A to 1B and 2A to 2B and the example electronic device 300 depicted in FIG. 3 may include additional features and that some of the features described herein may be removed and/or modified without departing from the scopes of the apparatus 100 and/or the electronic device 300.

The apparatus 100 may include a sleeve 102 (also referred to herein as a cable sleeve). The sleeve 102 may include a recess 104 to accommodate cables, such as cables 308 depicted in FIG. 3. In some examples, the sleeve 102 may have an elongated shape, and the recess 104 may have a corresponding shape that may extend along a length of the sleeve 102.

In some examples, the sleeve 102 may have a round shape, such as a tubular shape, or another appropriate type of shape that may accommodate cables. In some examples, the recess 104 may extend along a length of the sleeve 102. The distal ends of the sleeve 102 may be closed, or one or both distal ends may be open.

The apparatus 100 may include a ring 106 (also referred to herein as a lock ring), which may be rotatably coupled to the sleeve 102. The ring 106 may have a shape that corresponds to a shape of the sleeve 102. In some examples, the ring 106 may have a round shape, such as a tubular shape, which may correspond to a shape and size of the sleeve 102. For instance, a width or diameter of the ring 106 may accommodate the width or diameter of the sleeve 102. A length of the ring 106 may be substantially shorter than a length of the sleeve 102 as shown in FIGS. 1A and 1B.

The ring 106 may have an open section 108 between opposite distal ends of the ring 106. The ring 106 may have an upper edge 109 and a lower edge 110, which may extend from one distal end of the ring 106 to the other. In some examples, the ring 106 may have a semi-circular cross-section and the upper edge 109 and the lower edge 110 may have a semi-circular shape. In some examples, and as shown in FIGS. 1A, 2A, and 2B, the ring 106 may have grooves formed on an outer surface to allow increased grip friction when rotating the ring 106.

As depicted in FIG. 1B, the ring 106 may be rotatably coupled to the sleeve 102. In the open position, as depicted in FIG. 1B, the open section 108 of the ring 106 may be aligned, or face the same direction, with an opening 112 of the recess 104 in the sleeve 102, such that opening 112 to the recess 104 may be unobstructed and movement of the cables 308 (shown in FIG. 3) into and out of the recess 104 may be possible.

In the open position, the ring 106 may be positioned behind the sleeve 102. In the closed position and the locked position, as depicted in FIGS. 2A and 2B, respectively, the ring 106 may be positioned to extend across the opening 112 of the recess 104, thereby securing the cables 308 within the recess 104.

In some examples, the ring 106 may slide longitudinally with respect to the sleeve 102, for instance in a direction along a length of the sleeve 102, as well as rotate around the sleeve 102 or about a central or longitudinal axis of the sleeve 102. As such, the ring 106 and the sleeve 102 may be friction fitted to each other, which may secure the ring 106 to the sleeve 102 as well as provide improved control and tactile feedback as the ring 106 is manipulated.

The ring 106 may have a tab 114 formed on an inner surface of the ring 106. The sleeve 102 may have slots to engage with the tab 114 as the ring 106 is rotated. In some examples, the sleeve 102 may include a first slot 116 formed on a first side or a first edge of the sleeve 102 and a second slot 118 formed on a second side or another edge of the sleeve 102. The first slot 116 and the second slot 118 may be positioned at opposite sides of the recess 104. For instance, the first side of the sleeve 102 and the second side of the sleeve 102 may be opposite sides in an axial direction across the recess 104. The first slot 116 and the second slot 118 may be axially aligned along the sleeve. The first slot 116 may accommodate the tab 114 in the closed position or the locked position, as depicted in FIGS. 2A and 2B, respectively, and the second slot 118 may accommodate the tab 114 in the open position, as depicted in FIG. 1B. When engaged with the tab 114, the first slot 116 and the second slot 118 may restrict longitudinal movement of the ring 106.

In some examples, the tab 114 may include protrusions formed at a distal end of the tab 114. The protrusions in the tab 114 may secure the ring 106 to the sleeve 102 when the tab 114 is inserted into either the first slot 116 or the second slot 118. In some examples, a width of the tab 114 and widths of the first slot 116 and the second slot 118 may be set such that the tab 114 may be friction fitted with the first slot 116 and the second slot 118.

The first slot 116 may include a guide section 120 and a notch 122 that may be formed adjacent to the guide section 120. As the ring 106 is rotated to the closed position, the tab 114 may be inserted into the guide section 120 of the first slot 116.

In some examples, the sleeve 102 may include a first stop 124 and a second stop 126. The first stop 124 and the second stop 126 may restrict movement of the ring 106 in a longitudinal direction, for instance, in a direction along a length of the sleeve 102. For instance, as depicted in FIG. 1B, when the ring 106 is in the open position, the upper edge 109 of the ring 106 may contact the first stop 124. The first stop 124 may be a step formed on an edge of the sleeve 102, which may restrict movement of the ring 106, for instance, in an upward direction. In this example, as depicted in FIG. 2A, when the ring 106 is rotated such that the tab 114 is inserted in the guide section 120 of the first slot 116, the upper edge 109 of the ring 106 may contact the first stop 124, which may allow the tab 114 and the guide section 120 to be aligned. As such, the first stop 124 and the guide section 120 may guide the tab 114 as the ring 106 is rotated into the closed position.

The ring 106 may be moved from the closed position to the locked position, as depicted in FIG. 2B. In some examples, when the ring 106 is moved to the locked position, the tab 114 may be moved within the first slot 116 from the guide section 120 to the notch 122. The notch 122 may extend from the guide section 120 in a direction that may restrict rotation of the ring 106, for instance, a direction perpendicular to the guide section 120.

In some examples, the sleeve 102 may include a second stop 216, which may be a step formed on an edge of the sleeve 102 to restrict longitudinal movement of the ring 106, for instance in a downward direction. In this case, when the ring 106 is moved downward to be placed in the locked position, the lower edge 110 of the ring 106 may contact the second stop 126 as the tab 114 is positioned in the notch 122. As such, the ring 106 may be placed in the locked position, in which rotation of the ring 106 may be restricted.

In the open position, the tab 114 may be positioned in the second slot 118 and the upper edge 109 of the ring 106 may contact the first stop 124, which may facilitate alignment of the tab 114 with the second slot 118. In this instance, the ring 106 may be positioned behind the sleeve 102, such that the opening 112 of the recess 104 may be unobstructed by the ring 106 to allow access to the cables 308. In some examples, the tab 114 may be friction fitted inside the second slot 118.

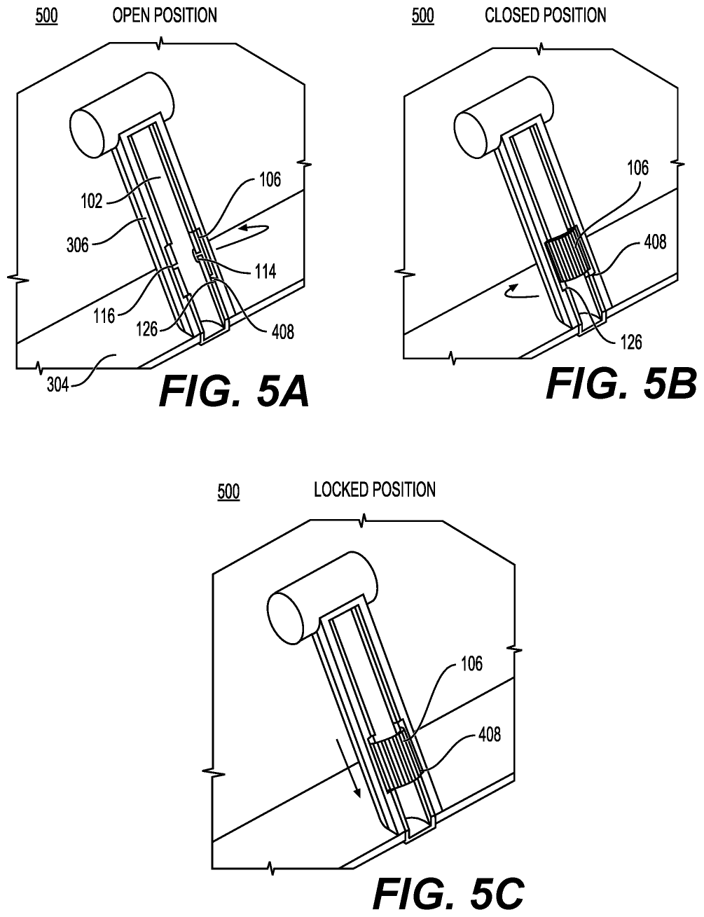

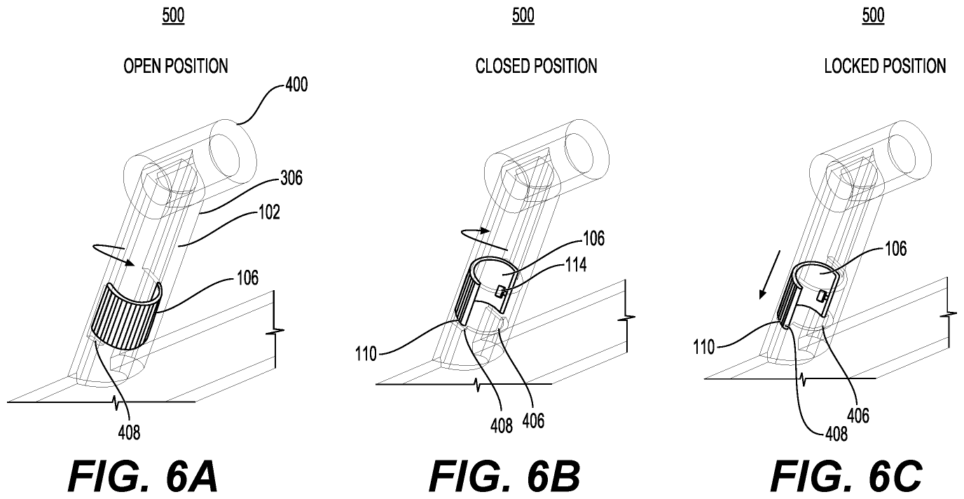

Reference is now made to FIGS. 4 to 5C. FIG. 4 shows a perspective view of an example stand 400 for an electronic device 300, in which the stand 400 may include a support to accommodate the sleeve 102 and the ring 106 depicted in FIGS. 1A to 1B. FIGS. 5A to 5C, respectively, show perspective views of an example cable lock assembly 500, which may include the sleeve 102 and the ring 106 depicted in FIGS. 1A to 1C, and which may be installed in the stand 400 depicted in FIG. 4, in which the ring 106 may be positioned in an open position, a closed position, and a locked position. FIGS. 6A to 6C, respectively, show rear cutaway views of the example sleeve 102, the example ring 106, and the example stand 400 depicted in FIGS. 5A to 5C. The descriptions of the example stand 400 and the example cable lock assembly 500 are made with reference to the features depicted in FIGS. 1A-1B, 2A-2B, and 3 for purposes of illustration. It should be understood that the stand 400 and the cable lock assembly 500 may include additional features and that some of the features described herein may be removed and/or modified without departing from the scopes of the stand 400 and/or the cable lock assembly 500.

In some examples, the stand 400 may include a base and a support attached to the base, such as the base 304 and the support 306 depicted in FIG. 3. The support 306 may be a component that is fabricated to be separate from the base 304 and mounted to the base 304 via fasteners or connectors, such as screws, tabs, and/or the like. In other examples, the support 306 may be formed as an integral part of the base 304. In any case, the support 306 may extend from the base 304 and may be mounted to the body 302 of the electronic device 300 to support the body 302 of the electronic device 300.

The stand 400 may be assembled together with the sleeve 102 and the ring 106 depicted in FIGS. 1A and 1B. As described herein, the cable lock assembly 500 may refer to a combination of a housing, such as a portion of the body of the stand 400 that forms the support 306, the sleeve 102, and the ring 106, assembled together. In this regard, the stand 400, or the housing for the support 306, may include structures to accommodate the sleeve 102 and the ring 106.

In some examples, the support 306 may include a channel 402, which may accommodate the sleeve 102. The channel 402 may form a recess that has a shape that is the same as the shape of the sleeve 102. In some examples, the sleeve 102 may be friction fitted within the channel 402, or alternatively or additionally, fasteners or connectors, such as screws, notches, tabs, and/or the like, may be provided to secure the sleeve 102 in the channel 402. When assembled together, an outer surface of the sleeve 102 may contact an inner surface of the support 306 inside the channel 402. In some examples, distal edges of the sleeve 102 and the channel 402, along a length of the sleeve 102 and the channel 402, may be flush relative to each other.

In some examples, a ring accommodation recess 404 may be formed on an inner surface of the support 306. The ring accommodation recess 404 may form a gap between the inner surface of the support 306 and an outer surface of the sleeve 102 that is adjacent to the ring accommodation recess 404. The gap may accommodate the ring 106 when the ring 106 is in the open position, as depicted in FIG. 5A. In the open position, the tab 114 on the ring 106 may be positioned in the second slot 118 on the sleeve 102, and the body of the ring 106 may be positioned behind the sleeve 102, inside the gap formed by the ring accommodation recess 404.

The support 306 may include a first step 406 formed at the ring accommodation recess 404 and a second step 408 formed adjacent to the first step 406. In some examples, the first step 406 may support the ring 106 when the ring 106 is positioned in the open position. As depicted in FIG. 5A, a lower edge 110 of the ring 106 may rest on the first step 406 when the ring 106 is rotated to the open position, such that the ring 106 is disposed in the gap between the support 306 and the sleeve 102. In this instance, the first step 406 may prevent movement of the ring 106 in a downward direction.

In some examples, the support 306 may include a third step 410, which may correspond to an upper edge of the ring 106. The third step 410 may support the upper edge 109 of the ring 106 to prevent longitudinal movement of the ring 106, for instance, in the upward direction. A distance between the first step 406 and the third step 410 may be set to correspond to a height of the ring 106, such that longitudinal movements of the ring 106 may be restricted while allowing rotational movement of the ring 106.

As depicted in FIGS. 5B and 6B, the ring 106 may be rotated from the open position to a closed position. In the closed position, the tab 114 may be positioned in the guide section 120 of the first slot 116. For instance, as the ring 106 is rotated to the closed position, the longitudinal position, or height, of the ring 106 may be set by the first step 406, and as such a longitudinal position of the tab 114 may be aligned with the guide section 120 of the first slot 116 to allow the tab 114 freely engage with the first slot 116.

In the closed position, in which the tab 114 is positioned in the guide section 120, distal ends of the ring 106 may rotate clear of the first step 406, and may be positioned over the second step 408. In this position, the ring 106 may be placed in the locked position, as depicted in FIGS. 5C and 6C. For instance, the ring 106 may be allowed to move longitudinally, for instance in a downward direction, such that the lower edge 110 of the ring 106 may rest on the second step 408 and the tab 114 may be moved into the notch 122, which may lock rotational movement of the ring 106.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

1. An apparatus comprising:
a sleeve having a recess to accommodate a cable, the sleeve to extend between a body of an electronic device and a base;
a ring rotatably coupled to the sleeve, the ring to extend across an opening of the recess in a locked position and to be positioned behind the recess in an open position; and
a support connected between the base and the body, the support having a channel to accommodate the sleeve.

2. The apparatus of claim 1, further comprising:
a tab disposed on the ring;
a first slot disposed on a first side of the sleeve; and
a second slot disposed on a second side of the sleeve, the first slot to accommodate the tab when the ring is in a closed position or the locked position and the second slot to accommodate the tab when the ring is in the open position.

3. The apparatus of claim 2, further comprising:
a notch formed inside the first slot, the notch to accommodate the tab when the ring is moved from the closed position to the locked position.

4. (canceled)

5. The apparatus of claim 1, further comprising:
a ring accommodation recess formed on an inner surface of the support, the ring accommodation recess to form a gap between the inner surface of the support and an outer surface of the sleeve.

6. The apparatus of claim 5, further comprising:
a first step formed on the ring accommodation recess, the first step to support the ring inside the ring accommodation recess when the ring is in the open position; and
a second step formed on the ring accommodation recess, the second step to support the ring when the ring is in the locked position.

7. A stand, comprising:
a base;
a support attached to the base, wherein the support is to support a body of an electronic device;
a cable sleeve disposed in the support, wherein the support has a channel formed in a body of the support, the channel having a shape to accommodate the cable sleeve inside the support; and
a lock ring rotatably coupled to the cable sleeve, the lock ring to extend across an opening of the cable sleeve in a locked position and the lock ring to be disposed behind the cable sleeve in an open position.

8. The stand of claim 7, further comprising:
a tab disposed on the lock ring;
a first slot disposed on a first side of the cable sleeve; and
a second slot disposed on a second side of the cable sleeve, the first slot to accommodate the tab when the lock ring is in a closed position or the locked position and the second slot to accommodate the tab when the lock ring is in the open position.

9. The stand of claim 8, further comprising:
a notch formed inside the first slot, the notch to accommodate the tab when the lock ring is moved from the closed position to the locked position.

10. (canceled)

11. The stand of claim 8, further comprising:
a ring accommodation recess formed on an inner surface of the channel, the ring accommodation recess to form a gap between the inner surface of the channel and an outer surface of the cable sleeve;
a first step formed on the ring accommodation recess, the first step to support the lock ring inside the ring accommodation recess when the lock ring is in the open position; and
a second step formed on the ring accommodation recess, the second step to support the lock ring when the lock ring is in the locked position.

12. A cable lock assembly, comprising:
a housing for a stand of an electronic device;
a sleeve disposed inside the housing, the sleeve having a recess to accommodate a cable, wherein the housing for the stand has a channel to accommodate the sleeve; and
a ring rotatably coupled to the sleeve, the ring to extend across an opening of the recess in a locked position and to be positioned between the housing and the sleeve in an open position.

13. The cable lock assembly of claim 12, further comprising:
a tab disposed on the ring;
a first slot disposed on a first side of the sleeve; and
a second slot disposed on a second side of the sleeve, the first slot to accommodate the tab when the ring is in a closed position or the locked position and the second slot to accommodate the tab when the ring is in the open position.

14. The cable lock assembly of claim 13, further comprising:
a notch formed inside the first slot, the notch to accommodate the tab when the ring is moved from the closed position to the locked position.

15. The cable lock assembly of claim 12, further comprising:
a ring accommodation recess formed on an inner surface of the housing, the ring accommodation recess to form a gap between the inner surface of the housing and an outer surface of the sleeve;
a first step formed on the ring accommodation recess, the first step to support the ring inside the ring accommodation recess when the ring is in the open position; and
a second step formed on the ring accommodation recess, the second step to support the ring when the ring is in the locked position.
